(19) United States
(12) Patent Application Publication
(10) Pub. No.: US 2017/0259699 A1
(43) Pub. Date: Sep. 14, 2017

(54) Vehicle Compartment Occupancy Warning and Safety System

(71) Applicant: Thien Lu, Vista, CA (US)

(72) Inventor: Thien Lu, Vista, CA (US)

(21) Appl. No.: 15/069,398

(22) Filed: Mar. 14, 2016

(51) Int. Cl. B60N 2/00; B60J 1/00

(52) U.S. Cl. CPC B60N 2/002; B60J 1/00

(57) ABSTRACT

A vehicle compartment occupancy warning and safety system includes a vehicle including components comprising a car horn, a plurality of headlights, a climate control assembly, and a plurality of electric windows. A power supply is electrically coupled to each of the components and a control circuit is electrically coupled to the components. A temperature sensor is mounted within the vehicle and measures a temperature of an interior the vehicle. The temperature sensor is electrically coupled to the control circuit. A motion sensor is electrically coupled to the control circuit and is positioned within the interior of the vehicle. The motion sensor is configured to detect motion within the vehicle. The control circuit actuates at least one of the components when the vehicle is turned off, the temperature sensor detects a temperature greater than a threshold temperature within the interior and the motion sensor detects motion within the interior.

### BACKGROUND OF THE DISCLOSURE

### Field of the Disclosure

The disclosure relates to vehicle occupancy detection devices and more particularly pertains to a new vehicle occupancy detection device for preventing an animal or person from being trapped within a vehicle while the interior of the vehicle experiences elevated temperatures.

### SUMMARY OF THE DISCLOSURE

An embodiment of the disclosure meets the needs presented above by generally comprising a vehicle including components comprising a car horn, a plurality of headlights, a climate control assembly, and a plurality of electric windows. A power supply is electrically coupled to each of the components and a control circuit is electrically coupled to the components. A temperature sensor is mounted within the vehicle and measures a temperature of an interior the vehicle. The temperature sensor is electrically coupled to the control circuit. A motion sensor is electrically coupled to the control circuit and is positioned within the interior of the vehicle. The motion sensor is configured to detect motion within the vehicle. The control circuit actuates at least one of the components when the vehicle is turned off, the temperature sensor detects a temperature greater than a threshold temperature within the interior and the motion sensor detects motion within the interior.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a schematic view of a vehicle compartment occupancy warning and safety system according to an embodiment of the disclosure.

FIG. 2 is a side view of an embodiment of the disclosure.

FIG. 3 is a broken perspective view of an embodiment of the disclosure.

FIG. 4 is a broken top view of an embodiment of the disclosure.

### DESCRIPTION OF THE PREFERRED EMBODIMENT

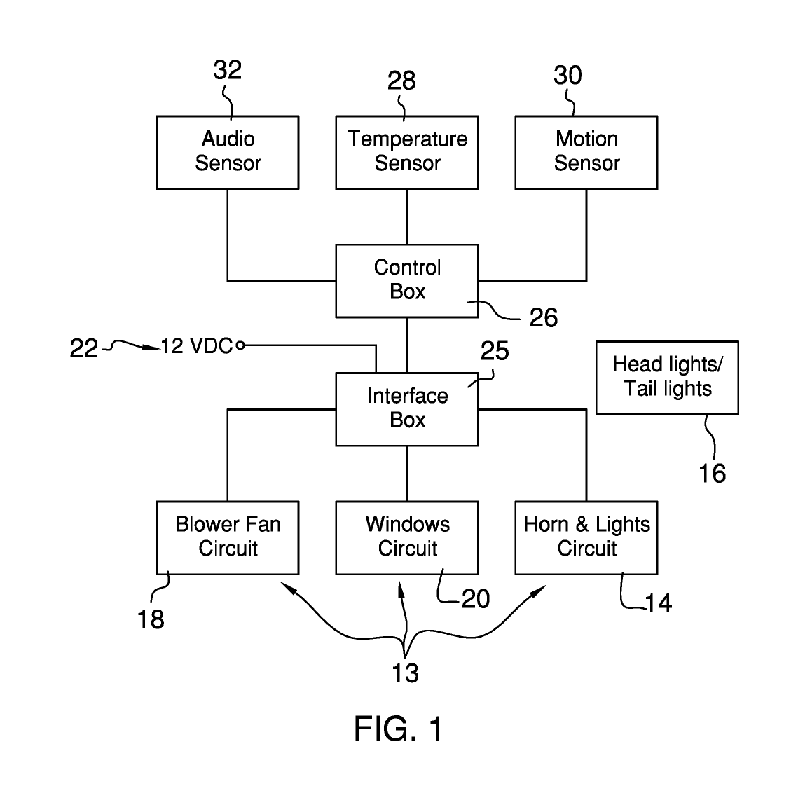

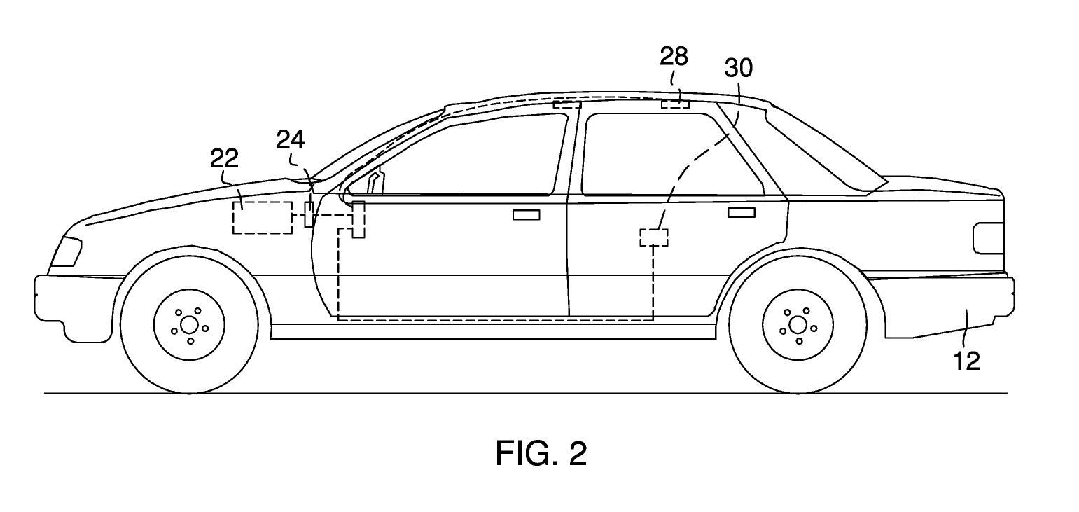

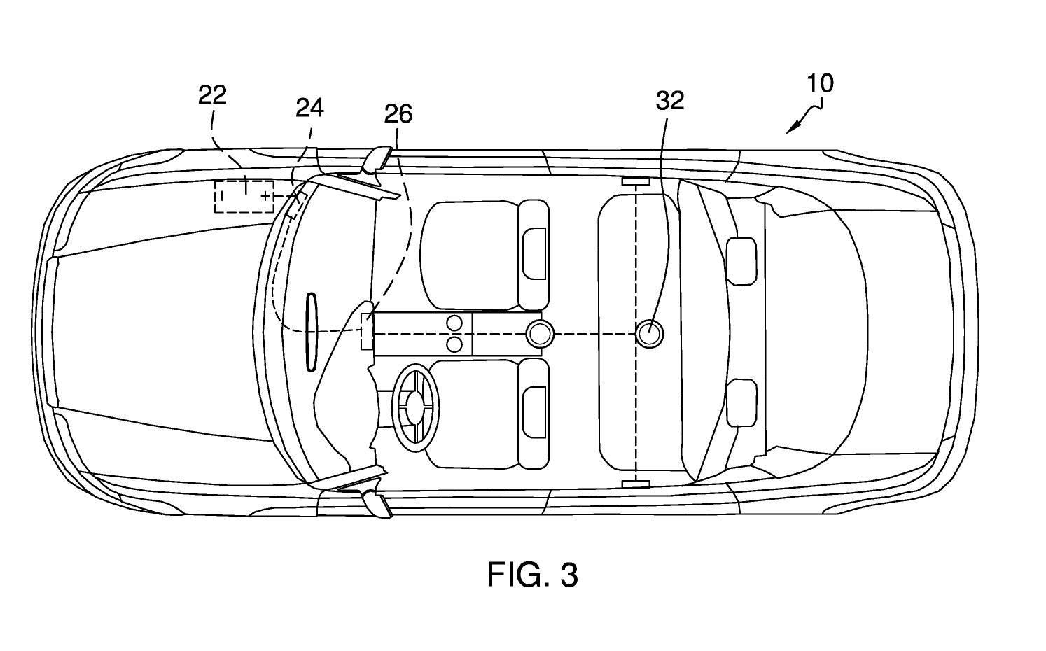

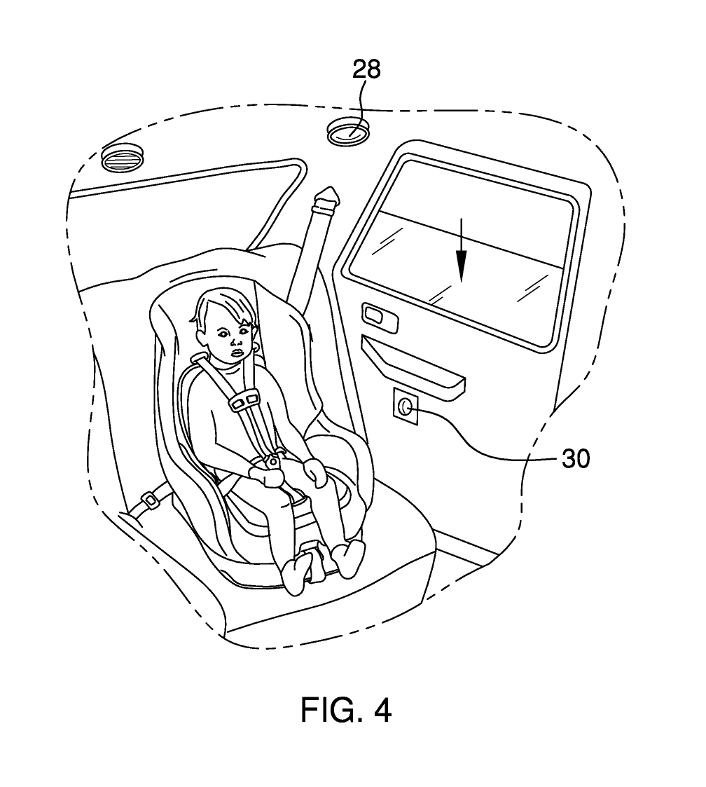

With reference now to the drawings, and in particular to FIGS. 1 through 4 thereof, a new vehicle occupancy detection device embodying the principles and concepts of an embodiment of the disclosure and generally designated by the reference numeral 10 will be described.

As best illustrated in FIGS. 1 through 4, the vehicle compartment occupancy warning and safety system 10 generally comprises a conventional vehicle 12 such as an automobile having a plurality of typical components 13 including a car horn 14, a plurality of headlights 16, a climate control assembly 18 and a plurality of electric windows 20. The electric windows 20 would include the glass window itself as well as an electric motor for lowering or lifting the glass window. The climate control assembly 18 would at least include a fan, or blower fan, for circulating air into the vehicle 12. A power supply 22 is electrically coupled to each of the components 13. The power supply may typically include a vehicle's 12V battery.

A control circuit 24 is electrically coupled to the components 13. The control circuit 24 may include a single circuit or multiple control circuits each integrated into a single onboard CPU which controls each of the components 13 or it may include an interface box 25 wired to the CPU, the interface box 26 being electrically coupled individually to the components 13 or a combination thereof to allow the system 10 to be retrofitted to existing vehicles 12. The control circuit 24 may further be electrically coupled to a control box 26 positioned within the vehicle 12 to allow a user to turn the system 10 off or to alter aspects of the system's 10 operation.

A temperature sensor 28 is mounted within the vehicle 12 and measures a temperature of an interior the vehicle 12. The temperature sensor 28 is electrically coupled to the control circuit 24. The temperature sensor 28 is conventional and may be positioned anywhere within the vehicle 12 such as on the ceiling of a rear portion of the interior of the vehicle 12.

A motion sensor 30 is electrically coupled to the control circuit 24 and is positioned within the interior of the vehicle 12. The motion sensor 30 is configured to detect motion within the vehicle 12 and may do so using any number of conventional means including RADAR and infra-red detection methods. The control circuit 24 actuates at least one of the components 13 when the vehicle 12 is turned off, the temperature sensor 28 detects a temperature greater than a threshold temperature within the interior and the motion sensor 30 detects motion within the interior. The threshold temperature may typically be between 85° F. and 95° F. However, the control box 26 may be configured to allow adjustment of this temperature depending on the intended occupant of the vehicle 12.

An audio sensor 32 is electrically coupled to the control circuit 42 and is positioned within the interior of the vehicle 12. The audio sensor 32 is configured to detect sound levels within the vehicle 12. The control circuit 24 actuates at least one of the components 13 when the vehicle 12 is turned off, the temperature sensor 28 detects a temperature greater than a threshold temperature within the interior and the audio sensor 32 detects sounds having a decibel level within the interior greater than a threshold decibel level. The threshold decibel level is greater than 80 decibels and, as with the threshold temperature, may be adjusted such that ambient sounds outside of the vehicle 12 do not easily activate the system 10.

When the system 10 is activated, the at least one of the components 13 may include any of the components 13 stated above. Typically, it would be preferred that the windows 20 would be actuated to an open position first to ensure that air may circulate through the vehicle 12 followed by the car horn 14 being sounded to alert a passerby that the vehicle is occupied. However, the fan 18 may be turned on as well to further increase air circulation and the headlights 16, and taillights, repeatedly turned on and off again to attract persons to the vehicle 12.

In use, the system 10 protects a person or an animal from hyperthermia by monitoring the temperature and activity within the vehicle 12. The motion sensor 30 and audio sensor 32 will detect motion and sounds within the vehicle 12 and activate the system 10 to actuate the various components 13 as stated above to both cool the interior of the vehicle 12 while also alerting people to the vehicle 12. Another feature which may be included is a transmitter electrically coupled to the control circuit 24 which utilizes cellular technology to notify the authorities and/or the owner of the vehicle 12 that the system has detected a person or animal within the vehicle 12 when the temperature threshold was attained.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle safety system configured to prevent an occupant from being harmed due to occupation of the vehicle beyond an internal temperature threshold of the vehicle, said system including:
a vehicle including components, said components comprising:
a car horn;
a plurality of headlights;
a climate control assembly;
a plurality of electric windows;
a power supply being electrically coupled to each of said components;
a control circuit being electrically coupled to said components;
a temperature sensor being mounted within said vehicle and measuring a temperature of an interior said vehicle, said temperature sensor being electrically coupled to said control circuit; and
a motion sensor being electrically coupled to said control circuit and being positioned within said interior of said vehicle, said motion sensor being configured to detect motion within said vehicle, said control circuit actuating at least one of said components when said vehicle is turned off, said temperature sensor detects a temperature greater than a threshold temperature within said interior and said motion sensor detects motion within said interior; and
an audio sensor being electrically coupled to said control circuit and being positioned within said interior of said vehicle, said audio sensor being configured to detect sound levels within said vehicle, said control circuit actuating at least one of said components when said vehicle is turned off, said temperature sensor detects a temperature greater than a threshold temperature within said interior and said audio sensor detects sounds having a decibel level within said interior greater than a threshold decibel level.

2. The vehicle safety system according to claim 1, wherein said threshold temperature is between 85° F. and 95° F.

3. (canceled)

4. The vehicle safety system according to claim 1, wherein said threshold decibel level being greater than 80 decibels.

5. The vehicle safety system according to claim 1, wherein at least one of said components at least includes said car horn being sounded and said electric windows being actuated to an open position.

6. The vehicle safety system according to claim 1, wherein at least one of said components at least includes said car horn being sounded and said electric windows being actuated to an open position.

7. A vehicle safety system configured to prevent an occupant from being harmed due to occupation of the vehicle beyond an internal temperature threshold of the vehicle, said system including:
a vehicle including components, said components comprising:
a car horn;
a plurality of headlights;
a climate control assembly;
a plurality of electric windows;
a power supply being electrically coupled to each of said components;
a control circuit being electrically coupled to said components;
a temperature sensor being mounted within said vehicle and measuring a temperature of an interior said vehicle, said temperature sensor being electrically coupled to said control circuit; and
an audio sensor being electrically coupled to said control circuit and being positioned within said interior of said vehicle, said audio sensor being configured to detect sound levels within said vehicle, said control circuit actuating at least one of said components when said vehicle is turned off, said temperature sensor detects a temperature greater than a threshold temperature within said interior and said audio sensor detects sounds having a decibel level within said interior greater than a threshold decibel level.

8. The vehicle safety system according to claim 7, wherein said threshold decibel level being greater than 80 decibels.

9. The vehicle safety system according to claim 8, wherein said threshold temperature is between 85° F. and 95° F.

10. The vehicle safety system according to claim 7, wherein at least one of said components at least includes said car horn being sounded and said electric windows being actuated to an open position.
